(19) United States
(12) Patent Application Publication
(10) Pub. No.: US 2009/0222368 A1
(43) Pub. Date: Sep. 3, 2009

(54) AUTHOR WEBSITE IN A COMMERCE ENVIRONMENT

(76) Inventors: DAVID Bruce McCauley, Greenwood, CA (US); Ryan Patrick Ladd, Indianapolis, IN (US)

Correspondence Address: Intellevate, P.O. Box 52050, Minneapolis, MN, 55402, US

(21) Appl. No.: 12/039,743

(22) Filed: Feb. 29, 2008

(51) Int. Cl. G06Q 30/00; G06F 3/00

(52) U.S. Cl. 705/35; 715/747

(57) ABSTRACT

A method, system and apparatus of an author website in a commerce environment are disclose. In one embodiment, a method of a merchant site includes creating, through an interaction module of the merchant site, an author website having at least some descriptive content of a literary work that is automatically applied from the merchant site to the author website based on a preference of an author of the literary work, automatically associating a user database of the merchant site to the author website, providing access to the author website from a location adjacent to where the literary work is marketed in the merchant site and providing an interface to enable a patron of the merchant site represented in the user database to communicate with the author of the literary work through at least one of the merchant site and the author website.

### FIELD OF TECHNOLOGY

This disclosure relates generally to the technical field of communications and, in one example embodiment, to a method, apparatus, and system of an author website in a commerce environment.

### BACKGROUND

A merchant (e.g., a bookstore) may have a website (e.g., a commerce portal) that includes information about a literary work (e.g., a book, a poem, a novel, a text, etc.). A user (e.g., a potential buyer, a reader, etc.) may read information about the literary work through the website. The user may wish to communicate with an author of the literary work prior to making a commitment to procure (e.g., buy, loan, rent, etc.) the literary work. The website of the merchant may not enable the author of the literary work to communicate with the user.

The author may maintain a separate website. The author may have to go to a number of different sources to acquire basic information on each literary work that they have written (e.g., ISBN number, retail price, etc.). This may be a time consuming and repetitive task. When information changes, the author may need to manually synchornize the separate website with the website of the merchant. The separate website may not be linked to the website of the merchant. The user may have to find the separate website by leaving the website of the merchant and searching for the author on a search engine (e.g., Google®, Yahoo®, etc.). In some instances, the author may not have the technical skills to create the separate website. As a result, the user may postpone a decision to procure the literary work because the user may not be able to get enough information about the literary work directly from the author.

### SUMMARY

A method, system and apparatus of author websites in a commerce environment are disclosed. In one aspect, a method of a merchant site includes creating, through an interaction module of the merchant site, an author website having at least some descriptive content of a literary work that is automatically applied from the merchant site to the author website based on a preference of an author of the literary work; automatically associating a user database of the merchant site to the author website; providing access to the author website from a location adjacent to where the literary work is marketed in the merchant site; and providing an interface to enable a patron of the merchant site represented in the user database to communicate with the author of the literary work through the merchant site and/or the author website. The method may include customizing a look and feel of the author website through a set of tools including a content placement tool, a blogging tool, a multi-media chat tool, a color-theme tool, a bulletin post tool, and/or an instant messaging tool.

The method may process a communication between the author and the patron through a video, an audio, a chat, a multimedia, and/or a discussion thread format (e.g., through the merchant site and/or the author website). The method may permit the patron to purchase the literary work through at least one of the merchant site and/or the author website. A royalty share may be allocated to the author when the purchase is made through the author website. The author website may provide an author related content that is independent of the descriptive content of the merchant site (e.g., an author biography, a set of details of other literary works of the author marketed on the merchant site, a fan club of patrons of the author, etc.). In addition, the interaction module may be embedded through a widget that can be placed across any number of social networking platforms to enable users of the social networking platforms to communicate with the author through the widget.

A set of packages may be provided to publish, edit and market the literary work of the author through the merchant website. The set of packages may include a first package to offer the author a mix of professional services and support that covers publishing essentials. A second package may offer the author a combination of products and services to customize the literary work. A third package may offer the author a time period for marketing the literary work. A fourth package may offer the author printing and publish services for the literary work.

In another aspect, a system includes an interaction module of a merchant site to automatically apply at least some descriptive content of a literary work offered in the merchant site to an author website based on a preference of an author of the literary work, a social networking platform associated with the author website which includes users who have shown an affinity for the literary work of the author in the merchant site, and a communication module of the interaction module to provide a multi-modal communication interface between the users who have shown an affinity for at the literary work and/or the author. A customization module of the interaction module may modify a look and feel of the author website through a set of tools (e.g., a content placement tool, a blogging tool, a multi-media chat tool, a color-theme tool, a bulletin post tool, and an instant messaging tool). The multi-modal communication interface may be a video, an audio, a chat, a multimedia, and/or a blog format between the users who have shown the affinity for the literary work and the author. A procurement module of the interaction module may enable the users to procure the literary work through the merchant site and/or the author website. A finance module of the interaction module may allocate a revenue to the merchant site when the procurement is conducted through the author website. A content creation module of the interaction module may enable the author to place an author biography, a set of details of other literary works of the author marketed on the merchant site, and/or a fan club of patrons of the author in the author website. A publishing module may enable the author to publish, edit and market the literary work of the author through the merchant website. Furthermore, an optional marketing module may enable authors to have a voice and build equity in their brand (i.e., their name/works) through promotion of their sites (e.g., upcoming events, a blog, online virtual book tours, and other promotional tools for the author to utilize on their website to promote their work and keep readers informed). A widget module of the interaction module may place the author website across different social networking platforms. Users of the different social networking platforms may communicate with the author through the widget.

In yet another embodiment, a method of an interaction module includes automatically applying a set of attributes associated with a literary work of an author from a merchant site to an author website generated through the interaction module, customizing a look and feel of the author website based on a preference of the author provided through the interaction module, accessing a user database of the merchant site to enable a user of the merchant site to communicate with the author through at least one of the author website and the merchant site, and allocating a royalty based on an agreement between the merchant site and a partner. The author website may leverage a description, an ISBN number, and/or content information from the merchant site. The interaction module may be leveraged across the merchant sites such that a single author interaction page is referenced to the merchant sites. A link may be placed to the author website directly adjacent to a location in which the literary work is marketed on the merchant site.

The methods, system, and apparatuses disclosed herein may be implemented in any means for achieving various aspects, and may be executed in a form of machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an author website associated with at least one merchant site, according to one embodiment.

FIG. 2 is an exploded view of the interaction module, according to one embodiment.

FIG. 3 is a table view of details associated with the user related to the literary work of the author in the social networking platform, according to one embodiment.

FIG. 4 is a user interface view of browsing the literary work through merchant website, according to one embodiment.

FIG. 5 is a user interface view of creating an author website through the interaction module of the merchant site, according to one embodiment.

FIG. 6 is a user interface view of the author website associated with the social networking platform in the merchant site, according to one embodiment.

FIG. 7 is a diagrammatic system view of a data processing system in which any of the embodiments disclosed herein may be performed, according to one embodiment.

FIG. 8A is a process flow to customize a look and feel of the author website through various tools, according to one embodiment.

FIG. 8B is a continuation of the process flow of FIG. 8A, showing additional processes, according to one embodiment.

FIG. 9 is a process flow of customizing, enabling communication and placing a link to the author website on merchant site, according to one embodiment.

Other features of the present embodiments will be apparent from the accompanying drawings and from the detailed description that follows.

### DETAILED DESCRIPTION

A method apparatus and system of an author website in a commerce environment are disclosed. In the following description, for the purposes of explanation, numerous specific details are set forth in order to provide a thorough understanding of the various embodiments. It will be evident, however to one skilled in the art that the various embodiments may be practiced without these specific details.

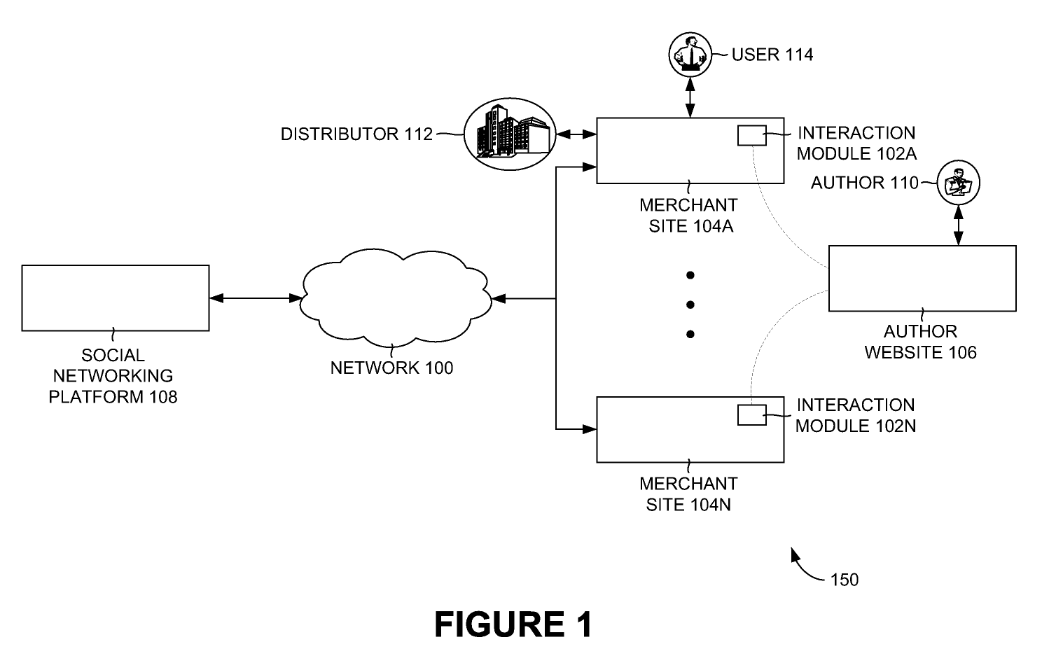

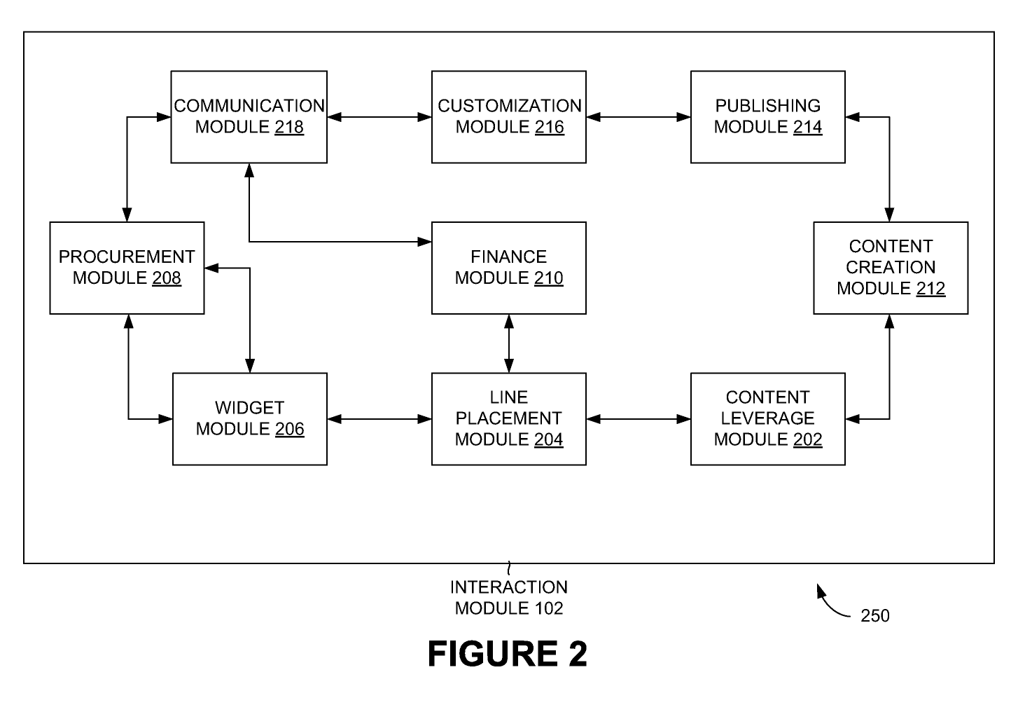

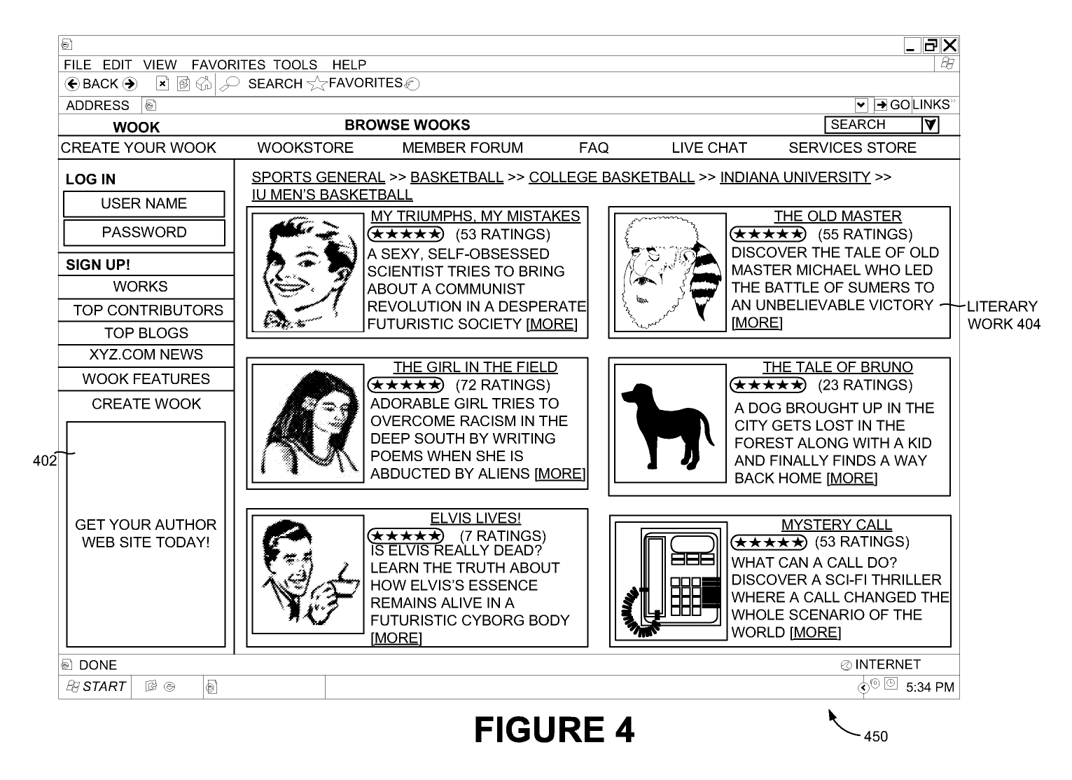

In one embodiment, a method of a merchant site 104 includes creating, through an interaction module (e.g., the interaction modules 102A-N of FIG. 1) of the merchant site (e.g., the merchant site 104A-N of FIG. 1), an author website (e.g., the author website 106 of FIG. 1) having some descriptive content of a literary work (e.g., the literary work 404 of FIG. 4) that is automatically applied from the merchant site 104A-N to the author website 106 based on a preference of an author (e.g., the author 110 of FIG. 1) of the literary work 404, automatically associating a user database of the merchant site 104A-N to the author website 106, providing access to the author website 106 from a location adjacent to where the literary work 404 is marketed in the merchant site 104A-N and providing an interface to enable a patron of the merchant site 104A-N represented in the user database to communicate (e.g., using the communication module 218 of FIG. 2) with the author 110 of the literary work 404 through the merchant site 104A-N and the author website 106.

In another embodiment, a system includes an interaction module 102 of a merchant site 104 to automatically apply some descriptive content of a literary work 404 offered in the merchant site 104A-N to an author website 106 based on a preference of an author 110 of the literary work 404, a social networking platform (e.g., the social networking platform 108 of FIG. 1) associated with the author website 106 which includes users 114 who have shown an affinity for the literary work 404 of the author 110 in the merchant site 104 and a communication module (e.g., the communication module 218 of FIG. 2) of the interaction module 102 to provide a multi-modal communication interface between the users 114 who have shown an affinity for the literary work 404 and the author 110.

In yet another embodiment, a method of an interaction module 102 includes automatically applying a set of attributes associated with a literary work 404 of an author 110 from a merchant site 104 to an author website 106 generated through the interaction module 102, customizing (e.g., using the customization module 216 of FIG. 2) a look and feel of the author website 106 based on a preference of the author 110 provided through the interaction module 102, accessing a user database of the merchant site 104 to enable a user 114 of the merchant site 104 to communicate with the author 110 through the author website 106 and the merchant site 104 and allocating a payment of the user 114 in procuring the literary work 404 based on an agreement between the merchant site 104 and a partner (e.g., a distributor, a publisher, a community site driving author website growth in exchange for revenue share, etc.).

FIG. 1 is a system view of an author website 106 associated with at least one merchant site 104A-N, according to one embodiment. Particularly, FIG. 1 illustrates a network 100, interaction modules 102A-N, merchant sites 104A-N, the author website 106, the social networking platform 108, the author 110, the distributor 112 and the user 114, according to one embodiment.

The network 100 (e.g., Internet, wireless Internet, WAN, LAN, Bluetooth, Wi-Fi, Wi-Max, telecommunications, radio frequency and/or infrared network, etc.) may enable communication between the author 110 and the user 114 through the social networking platform 108. The interaction modules 102A-N may automatically apply a descriptive content of the literary work (e.g., the literary work 404 of FIG. 4) offered in the merchant site 104A-N to the author website 106 based on a preference of the author 110 of the literary work.

The merchant sites 104A-N may enable the author 110 of the literary work 404 (e.g., book, journal, periodical, etc.) to communicate with the user 114. The author website 106 may provide an author related content along with a descriptive content of the literary work 404 that is automatically applied from the merchant sites 104A-N to the author website 106 based on a preference of the author 110 of the literary work 404. The social networking platform 108 (e.g., a network, a social network, a community, etc.) may include users 114 who have shown an affinity for the literary work 404 of the author 110 in the merchant site 104A-N. For example, the author 110 (e.g., writer, editor, co-editor, etc.) may make their creative dream a reality with the help of the user 114.

The author 110 may be composer of a literary work (e.g., the literary work 404 shown in FIG. 4). For example, the literary work 404 may include novels, poems, essays, books, journals and/or periodicals composed by the author 110. The distributor 112 may have an authority (e.g., exclusive rights) to market, sell, allocate, allot and/or deal with the literary work 404 in the social networking platform 108. The user 114 may be registered users and/or unregistered users of the social networking platform 108. For example, the users 114 may include patrons, readers, writers, followers, observers, fans and/or contributors who desire to interact with the author 110 in the social networking platform 108.

In the example embodiment illustrated in FIG. 1, the merchant site 104A-N interacts with the social networking platform 108 through the network 100. The merchant site 104A-N also interacts with the distributor 112 and the user 114. In addition, the merchant sites 104A-N includes the interaction modules 102A-N which communicates with the author 110 through the author website 106.

In one embodiment, through an interaction module (e.g., the interaction module 102A-N of FIG. 1) of the merchant site (e.g., the merchant site 104A-N of FIG. 1), an author website (e.g., the author website 106 of FIG. 1) may be created having some descriptive content of a literary work (e.g., the literary work 404 of FIG. 4) that is automatically applied from the merchant site 104A-N to the author website 106 based on a preference of an author (e.g., the author 110 of FIG. 1) of the literary work 404. For example, the author website 106 provides an author related content that is independent of the descriptive content of the merchant site 104A-N including an author biography, a set of details of other literary works 404 of the author 110 marketed on the merchant site 104A-N, and a fan club of patrons of the author 110.

A user database of the merchant site 104A-N may be automatically associated to the author website 106. Access may be provided to the author website 106 from a location adjacent to where the literary work 404 is marketed in the merchant site 104A-N. An interface may be provided to enable a patron of the merchant site 104A-N represented in the user database to communicate with the author 110 of the literary work 404 through the merchant site 104A-N and the author website 106.

A communication between the author 110 and the patron may be processed through a video, an audio, a chat, a multimedia, and a discussion thread format, either through the merchant site 104A-N and the author website 106. The interaction module 102A-N of the merchant site 104A-N may automatically apply some descriptive content of a literary work 404 offered in the merchant site 104A-N to the author website 106 based on a preference of the author 110 of the literary work 404.

The social networking platform 108 may be associated with the author website 106 (e.g., leverages a description, an ISBN number, and/or a content information from the merchant site 104A-N) which includes users 114 who have shown an affinity for the literary work 404 of the author 110 in the merchant site 104A-N. A set of attributes associated with the literary work 404 of the author 110 may be automatically applied from the merchant site 104A-N to the author website 106 generated through the interaction module 102A-N. For example, the interaction module 102A-N may be leveraged across the merchant sites 104A-N such that a single author interaction page is referenced to the merchant sites 104A-N.

FIG. 2 is an exploded view 250 of the interaction module 102, according to one embodiment. Particularly, FIG. 2 illustrates the interaction module 102, a content leverage module 202, a line placement module 204, a widget module 206, a procurement module 208, a finance module 210, a content creation module 212, a publishing module 214, a customization module 216 and a communication module 218, according to one embodiment.

The content leverage module 202 may leverage across the merchant sites 104A-N such that the single author interaction page is referenced to the merchant sites 104A-N. The line placement module 204 may include a set of tools having a content placement tool, a blogging tool, a multi-media chat tool, a color-theme tool, a bulletin post tool, and an instant messaging tool in the author website 106. The widget module 206 may place the author website 106 across the social networking platforms 108 to enable users 114 of the social networking platforms 108 to communicate with the author 110 through the widget.

The procurement module 208 may enable the users 114 to procure the literary work 404 through the merchant sites 104A-N and the author website 106. The finance module 210 may allocate a revenue (e.g., from a publisher) to the to the merchant sites 104A-N (e.g., and/or a partner site, an online community, etc.) when the procurement is conducted through the author website 106. The content creation module 212 may enable the author 110 to place an author biography, a set of details of other literary works 404 of the author 110 marketed on the merchant sites 104A-N, and a fan club of patrons of the author 110 in the author website 106. The publishing module 214 may enable the author 110 to publish, edit and market the literary work 404 of the author 110 through the merchant website 104A-N. Furthermore, an optional marketing module may enable authors to have a voice and build equity in their brand (i.e., their name/works) through promotion of their sites (e.g., upcoming events, a blog, online virtual book tours, and other promotional tools for the author to utilize on their website to promote their work and keep readers informed).

The customization module 216 may enable modifying a look and feel of the author 110 website through a set of tools including a content placement tool, a blogging tool, a multi-media chat tool, a color-theme tool, a bulletin post tool, and an instant messaging tool. The communication module 218 may provide a multi-modal communication interface between the users 114 who have shown an affinity for the literary work 404 and the author 110.

In the example embodiment illustrated in FIG. 2, the interaction module 102 includes the content leverage module 202, the line placement module 204, the widget module 206, the procurement module 208, the finance module 210, the content creation module 212, the publishing module 214, the customization module 216 and the communication module 218 communicating with each other.

In one embodiment, a look and feel of the author website (e.g., the author website 106 of FIG. 1) may be customized through a set of tools including a content placement tool, a blogging tool, a multi-media chat tool, a color-theme tool, a bulletin post tool, and an instant messaging tool. The patron may be permitted to purchase the literary work (e.g., the literary work 404 of FIG. 4) through the merchant site (e.g., the merchant site 104A-N of FIG. 1) and the author website 106.

A royalty share may be allocated to the author (e.g., the author 110 of FIG. 1) when the purchase is made through the author website 106. A set of packages may be provided to publish, edit and market the literary work 404 of the author 110 through the merchant website 104A-N. For example, the set of packages includes a first package to offer the author 110 a mix of professional services and support that covers publishing essentials, a second package to offer the author 110 a combination of products and services to customize the literary work 404, a third package to offer the author 110 a time period for marketing the literary work 404, and a fourth package to offer the author 110 printing and publish services for the literary work 404.

The interaction module (e.g., the interaction module 102A-N of FIG. 1) may be embedded through a widget that can be placed across the social networking platform 108 to enable users 114 of the social networking platforms 108 to communicate with the author 110 through the widget. The communication module 218 of the interaction module 102A-N may provide a multi-modal communication interface between the users 114 who have shown an affinity for the literary work 404 and/or the author 110. The customization module 216 of the interaction module 102A-N may modify a look and feel of the author website 106 through a set of tools including a content placement tool, a blogging tool, a multi-media chat tool, a color-theme tool, a bulletin post tool, and an instant messaging tool. For example, the multi-modal communication interface may be a video, an audio, a chat, a multimedia, and/or a blog format between the users 114 who have shown the affinity for the literary work 404 and/or the author 110.

The procurement module 208 of the interaction module 102A-N may enable the users 114 to procure the literary work 404 through the merchant site 104A-N and the author website 106. The finance module 210 of the interaction module 102A-N may allocate a revenue between the partner sites and the merchant site 104A-N when the procurement is conducted through the author website 106 (e.g., may belong to that partner site). The content creation module 212 of the interaction module 102A-N may enable the author 110 to place an author biography, a set of details of other literary works 404 of the author 110 marketed on the merchant site 104A-N, and a fan club of patrons of the author 110 in the author website 106.

The publishing module 214 may enable the author 110 to publish, edit and market the literary work 404 of the author 110 through the merchant website 104A-N. The widget module 206 of the interaction module 102A-N may place the author website 106 across the social networking platform 108 to enable users 114 of the social networking platform 108 to communicate with the author 110 through the widget. The look and feel of the author website 106 based on a preference of the author 110 may be customized provided through the interaction module 102A-N. A user database of the merchant site 104A-N may be accessed to enable the user 114 of the merchant site 104A-N to communicate with the author 110 through the author website 106 and the merchant site 104A-N. A payment of the user 114 may be allocated in procuring the literary work 404 based on an agreement between the merchant site 104A-N and the partners.

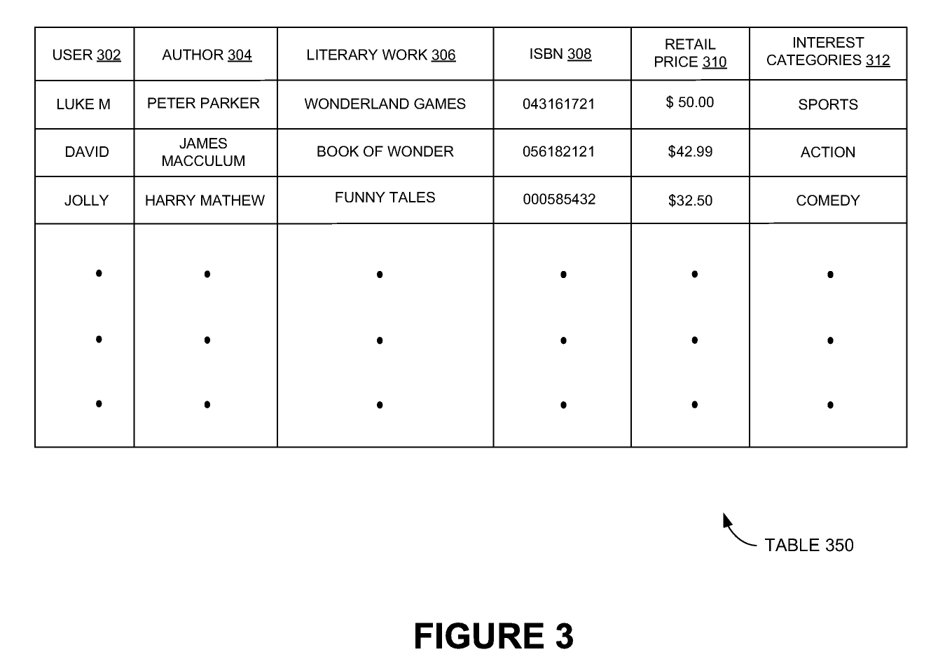

FIG. 3 is a table view of details associated with the user 114 related to the literary work (e.g., the literary work 404 of FIG. 4) of the author 110 in the social networking platform 108, according to one embodiment. Particularly, FIG. 3 illustrates a user field 302, an author field 304, a literary work field 306, an ISBN field 308, a retail price field 310 and interest categories field 312, according to one embodiment.

The user field 302 may display unique identity code (e.g., name, code, unique key, etc.) referencing users 114 in the author website 106. The author field 304 may display the name of the author 110 associated with the literary work (e.g., the literary work 404 of FIG. 4) in the author website 106. The literary work field 306 may display the title of the literary work 404 associated with the author 110 of the literary work 404. The ISBN field 308 may display an identification number that is unique for every literary work 404(e.g., book, novel, etc.). The retail price field 310 may display the price charged for the particular literary work 404 in the author website 106. The interest categories field 312 may display the classification under which the literary work 404 is associated in the author website 106.

In the example embodiment illustrated in FIG. 3, the user field 302 displays “Luke M” in the first row, “David” in the second row, “Jolly” in the third row, indicating the name of the users 114 in the user field column 302. The author field 304 displays “Peter Parker” in the first row, “James Macculum” in the second row, “Harry Mathew” in the third row, indicating the name of the author 110 in the author field column 304. The literary work field 306 displays “Wonderland Games” in the first row, “Book of Wonder” in the second row, “Funny Tales” in the third row, indicating the title of the literary work 404 in the literary work field column 306.

The ISBN field 308 displays “043161721” in the first row, “056182121” in the second row, “000585432” in the third row, indicating an identification number that is unique for every literary work (e.g., book, novel, etc.) in the ISBN field column 308. The retail price field 310 displays “$50.00” in the first row, “$42.99” in the second row, “$32.50” in the third row, indicating the price charged for the particular literary work in the author website 106 in the retail price field column 310. The interest categories field 312 displays “Sports” in the first row, “Action” in the second row, “Comedy” in the third row, indicating the classification under which the literary work is associated in the author website 106 in the interest categories field column 312.

FIG. 4 is a user interface view 450 of browsing the literary work 404 through merchant website (e.g., the merchant sites 104A-N of FIG. 1), according to one embodiment. Particularly, FIG. 4 illustrates an option 402 and a literary work 404, according to one embodiment.

The option 402 may enable the users 114 to sign up for the author website 106 which is an online community of authors 110 (e.g., writer, editor, co-editor, etc.) who want to make their creative dream a reality with the help of the users 114. The literary work 404 may spring from a seed of creativity expressed and composed as a written work by the author 110.

In the example embodiment illustrated in FIG. 4, the user interface view 450 may enable the users 114 (e.g., registered users and/or unregistered users) to browse for the literary work 404. The user interface view 450 displays the literary work 404 such as “My Triumphs, My Mistakes”, “The girl in the field”, “Elvis Lives”, etc. on the webpage along with the rating and the descriptive content of the literary work 404. The literary work 404 may be displayed on the webpage based on the search conducted by the users 114. Furthermore, the unregistered users may register into the website to become members of the author website 106 of the merchant site 104.

In one embodiment, a link to the author website 106 may be placed directly adjacent to a location in which the literary work 404 is marketed on the merchant site 104A-N.

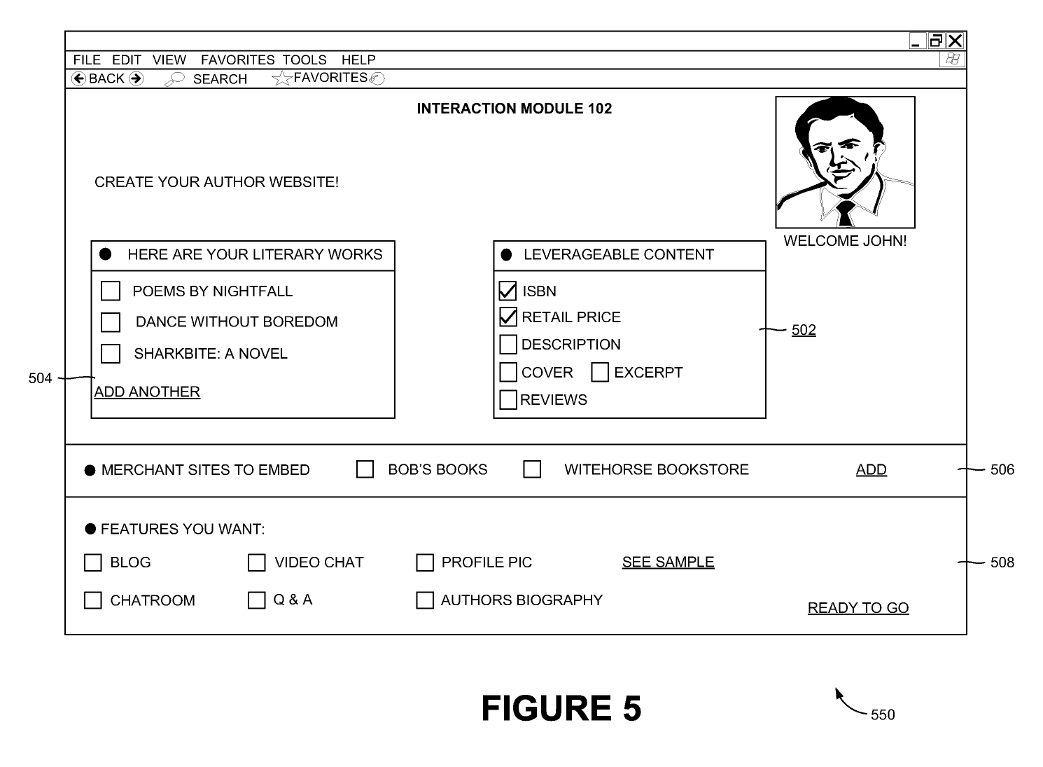

FIG. 5 is a user interface view 550 of creating an author website 106 through the interaction module 102 of the merchant site 104, according to one embodiment. Particularly, FIG. 5 illustrates a leverageable content option 502, here are your literary work option 504, merchant sites 104A-N to embed option 506, and features you want option 508.

In the example embodiment illustrated in FIG. 5, the user interface view 550 displays various options to the author 110 (e.g., John) such that a single author interaction page is referenced to various merchant sites 104A-N (e.g., Bob's Books, WiteHorse Bookstore, etc.). In addition, the user interface view 550 also displays various literary works of the author 110 and options to process a communication between the author 110 and the patron through a blog, a video chat, a profile picture, a chat room, a Q & A, an authors biography, etc.

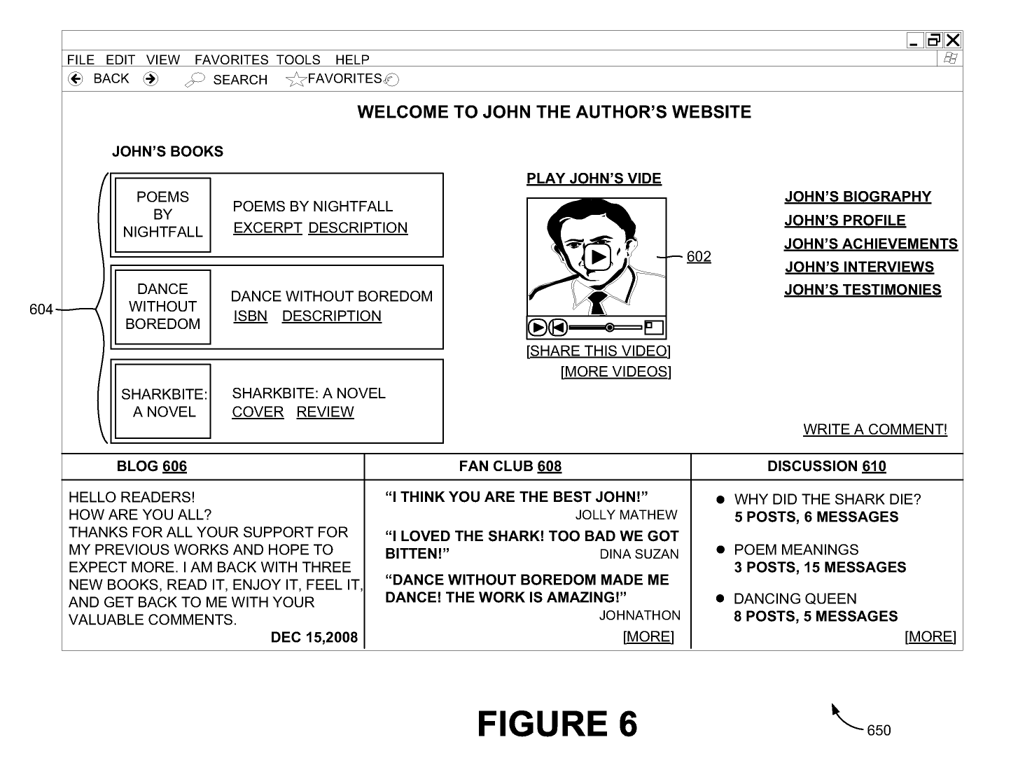

FIG. 6 is a user interface view 650 of the author website 106 associated with the social networking platform 108 in the merchant site 104, according to one embodiment. Particularly, FIG. 6 illustrates a play video block 602, a list books block 604, a blog block 606, a fan club block 608 and a discussion block 610, according to one embodiment.

The play video block 602 may enable the author 110 to place an author biography, testimonies, interviews and achievements by adding videos to their website (e.g., the author website 106 of FIG. 1). The list books block 604 may display a set of details of the other literary works of the author 110 marketed on the merchant site 104. The blog block 606 may allow the author 110 to post messges and/or topics periodically allowing the patrons to comment. The fan club block 608 may have a fan club of patrons of the author 110 and/or the literary works 404 composed by the author 110 in the author website 106. The discussion block 610 may include a guestbook where patrons can leave comments, messages and/or posts mails visible on the author's webpage. For example, the patrons may communicate with the author 110 in real time (e.g., phone, real phone, video chat, etc.) and/or near-synchronous (e.g., IM, text chat, etc.).

In the example embodiment illustrated in FIG. 6, the user interface view 650 displays the author website 106 having author's videos, the set of details of the other literary works, author's blog, fan club, and/or discussion forum. In addition, the user interface view 650 allows patrons to visit the author's webpage, view the literary works, videos and leave comments, messages and/or posts mails to the author's website 106.

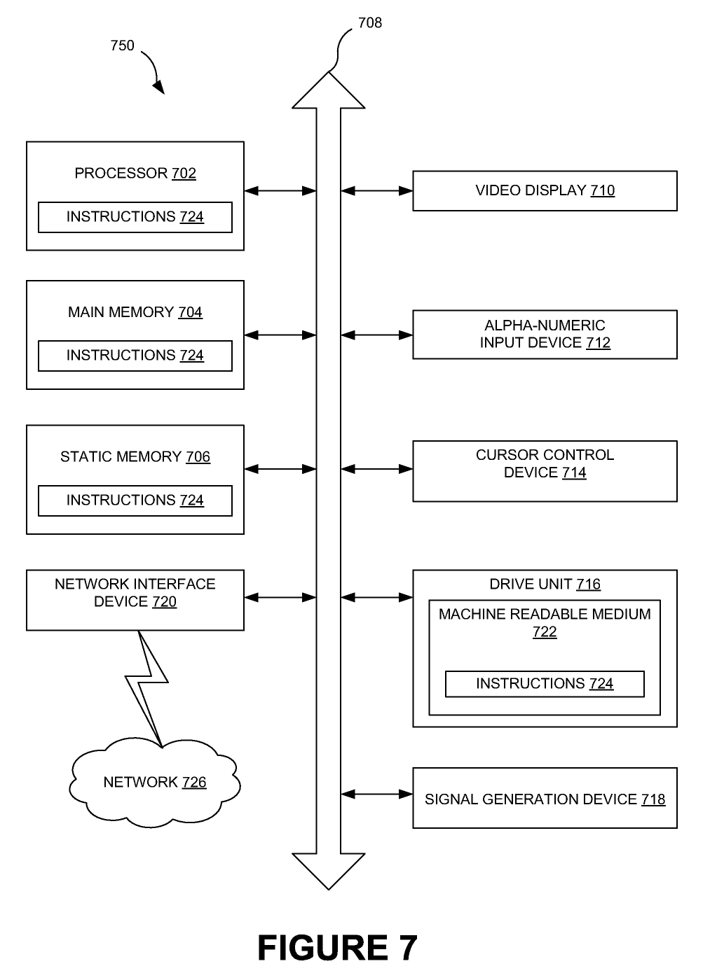

FIG. 7 is a diagrammatic system view 750 of a data processing system in which any of the embodiments disclosed herein may be performed, according to one embodiment. Particularly, the diagrammatic system view 750 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724 and a network 726, according to one embodiment.

The diagrammatic system view 700 may indicate a personal computer and/or a data processing system in which one or more operations disclosed herein may be performed. The processor 702 may be a microprocessor, a state machine, an application-specific integrated circuit, a field programmable gate array, etc. (e.g., Intel® Pentium® processor). The main memory 704 may be a dynamic random access memory and/or a primary memory of a computer system. The static memory 706 may be a hard drive, a flash drive, and/or other memory information associated with the data processing system.

The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically challenged). The cursor control device 714 may be a pointing device such as a mouse.

The drive unit 716 may be the hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from a network 726.

The machine readable medium 722 may provide instructions on which any of the methods disclosed herein may be performed. The instructions 724 may provide source code and/or data code to the processor 702 to enable any one or more operations disclosed herein.

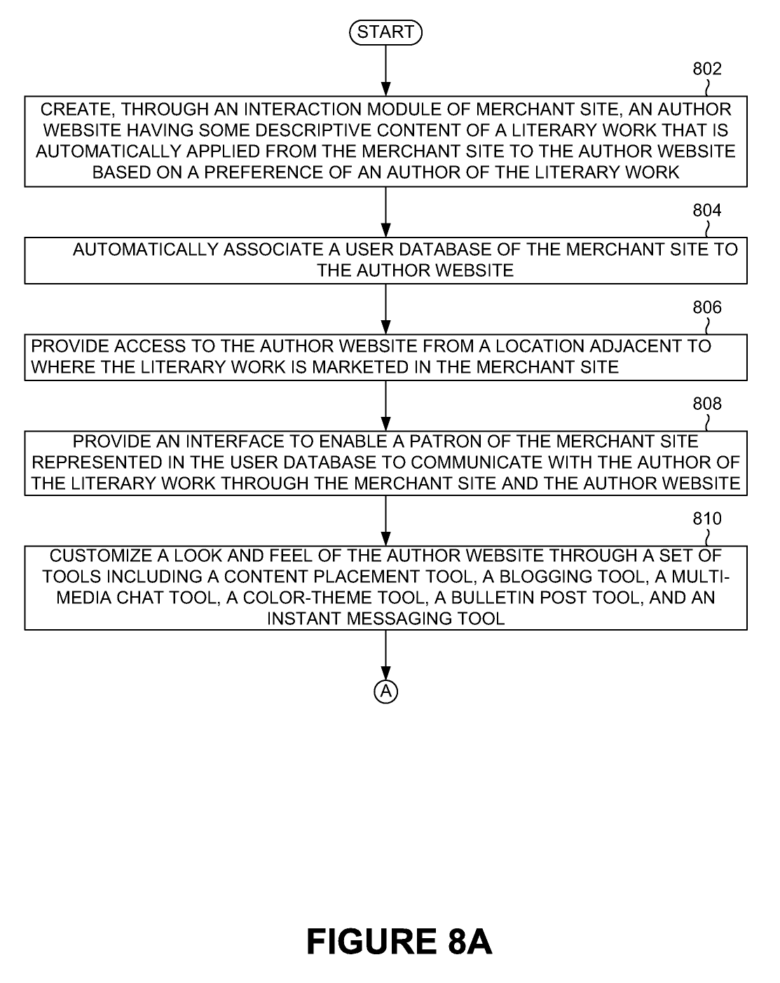

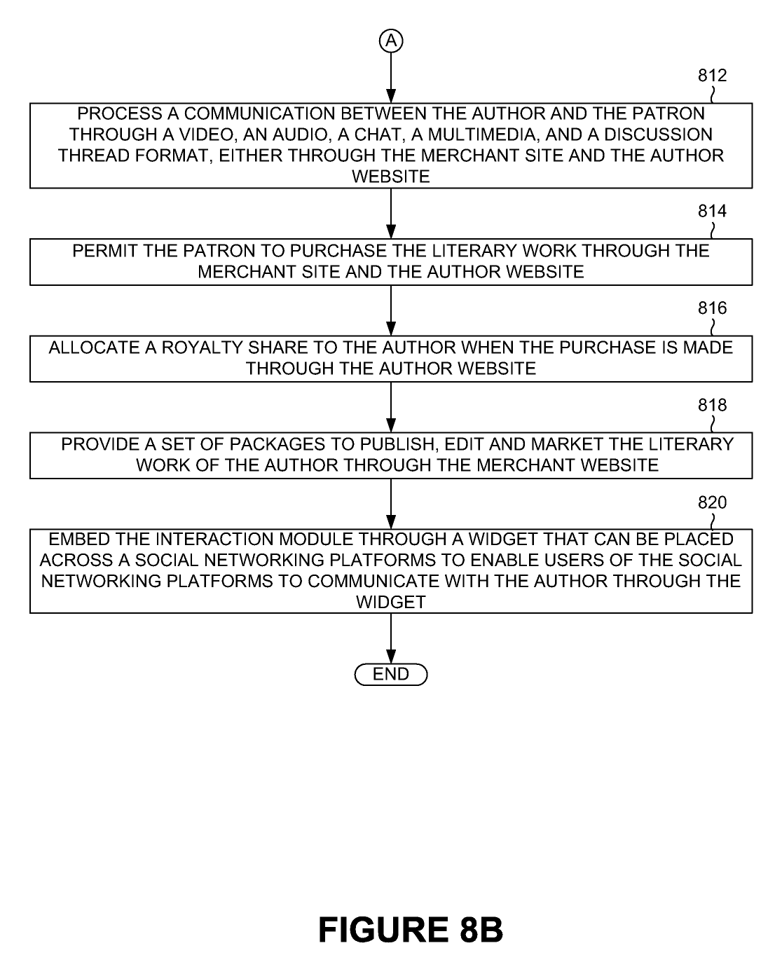

FIG. 8A is a process flow to customize a look and feel of the author website (e.g., the author website 106 of FIG. 1) through various tools, according to one embodiment. In operation 802, through an interaction module (e.g., the interaction module 102A-N of FIG. 1) of an merchant site (e.g., the merchant site 104A-N of FIG. 1), an author website 106 may be created having some descriptive content of a literary work (e.g., the literary work 404 of FIG. 4) that is automatically applied from the merchant site 104A-N to the author website 106 based on a preference of an author (e.g., the author 110 of FIG. 1) of the literary work 404.

In operation 804, a user database of the merchant site 104A-N may be automatically associated to the author website 106 (e.g., may provide an author related content that is independent of the descriptive content of the merchant site 104A-N including an author biography, a set of details of other literary works 404 of the author 110 marketed on the merchant site 104, and/or a fan club of patrons of the author 110). In operation 806, access to the author website 106 may be provided from a location adjacent to where the literary work 404 is marketed in the merchant site 104A-N.

In operation 808, an interface to enable a patron of the merchant site 104A-N represented in the user database may be provided to communicate (e.g., using the communication module 218 of FIG. 2) with the author 110 of the literary work 404 through the merchant site 104A-N and/or the author website 106. In operation 810, a look and feel of the author website 106 may be customized (e.g., using the customization module 216 of FIG. 2) through a set of tools including a content placement tool, a blogging tool, a multi-media chat tool, a color-theme tool, a bulletin post tool, and/or an instant messaging tool.

FIG. 8B is a continuation of the process flow of FIG. 8A, showing additional processes, according to one embodiment. In operation 812, a communication between the author 110 and the patron may be processed through a video, an audio, a chat, a multimedia, and/or a discussion thread format, either through the merchant site 104A-N and/or the author website 106.

In operation 814, the patron may be permitted to purchase the literary work 404 through the merchant site 104A-N and/or the author website 106. In operation 816, a royalty share may be allocated (e.g., using the finance module 210 of FIG. 2) to the author 110 when the purchase is made through the author website 106. In operation 818, a set of packages may be provided (e.g., using the publishing module 214 of FIG. 2) to publish, edit and/or market the literary work 404 of the author 110 through the merchant website 104A-N.

For example, the set of packages includes a first package to offer the author 110 a mix of professional services and/or support that covers publishing essentials, a second package to offer the author 110 a combination of products and services to customize the literary work 404, a third package to offer the author 110 a time period for marketing the literary work 404, and a fourth package to offer the author 110 printing and publish services for the literary work 404. In operation 820, the interaction module 102A-N may be embedded through a widget that can be placed across social networking platforms 108 to enable users 114 of the social networking platforms 108 to communicate with the author 110 through the widget (e.g., using the widget module 206 of FIG. 2).

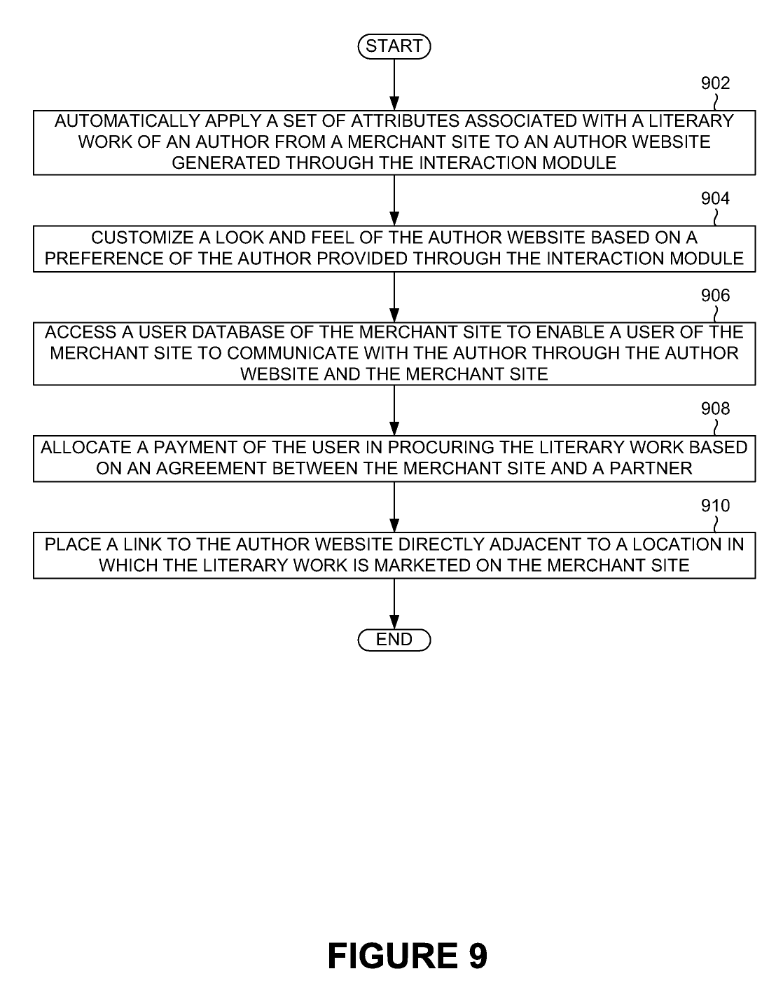

FIG. 9 is a process flow of customizing, enabling communication and placing a link to the author website 106 on merchant site 104A-N, according to one embodiment. In operation 902, a set of attributes associated with a literary work 404 of an author 110 may be automatically applied from a merchant site 104A-N to an author website 106 generated through the interaction module 102A-N. In operation 904, a look and feel of the author website 106 based on a preference of the author 110 may be customized (e.g., using customization module 218 of FIG. 2) provided through the interaction module 102A-N.

In operation 906, the user database of the merchant site 104A-N may be accessed to enable the user 114 of the merchant site 104A-N to communicate (e.g., using the communication module 218 of FIG. 2) with the author 110 through the author website 106 and/or the merchant site 104A-N. In operation 908, a payment of the user 114 may be allocated (e.g., using the procurement module 208 of FIG. 2) in procuring the literary work 404 based on an agreement between the merchant site 104A-N and the partners (e.g., distribution channels, communities, retailers, etc.). In operation 910, a link to the author website 106 may be placed directly adjacent to a location in which the literary work 404 is marketed on the merchant site 104A-N.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the interaction module 102A-N, the content leverage module 202, the line placement module 204, the widget module 206, the procurement module 208, the finance module 210, the content creation module 212, the publishing module 214, the customization module 216, the communication module 218 and other modules of FIGS. 1-9 may be enabled using an interaction circuit, a content leverage circuit, a line placement circuit, a widget circuit, a procurement circuit, a finance circuit, a content creation circuit, a publishing circuit, a customization circuit, a communication circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in a illustrative rather than a restrictive sense.

What is claimed is:

1. A method of a merchant site, comprising:
creating, through an interaction module of the merchant site, an author website having at least some descriptive content of a literary work that is automatically applied from the merchant site to the author website based on a preference of an author of the literary work;
automatically associating a user database of the merchant site to the author website; providing access to the author website from a location adjacent to where the literary work is marketed in the merchant site; and
providing an interface to enable a patron of the merchant site represented in the user database to communicate with the author of the literary work through at least one of the merchant site and the author website.

2. The method of claim 1 further comprising customizing a look and feel of the author website through a set of tools including a content placement tool, a blogging tool, a multi-media chat tool, a color-theme tool, a bulletin post tool, and an instant messaging tool.

3. A method of claim 2, further comprising processing a communication between the author and the patron through at least one of a video, an audio, a chat, a multimedia, and a discussion thread format, either through at least one of the merchant site and the author website.

4. A method of claim 3, further comprising permitting the patron to purchase the literary work through at least one of the merchant site and the author website.

5. A method of claim 4, further comprising allocating a royalty share to the author when the purchase is made through the author website.

6. The method of claim 5, wherein the author website provides an author related content that is independent of the descriptive content of the merchant site including at least one of an author biography, a set of details of other literary works of the author marketed on the merchant site, and a fan club of patrons of the author.

7. The method of claim 1 further comprising providing a set of packages to publish, edit and market the literary work of the author through the merchant website.

8. The method of claim 7, wherein the set of packages includes a first package to offer the author a mix of professional services and support that covers publishing essentials, a second package to offer the author a combination of products and services to customize the literary work, a third package to offer the author a time period for marketing the literary work, and a fourth package to offer the author printing and publish services for the literary work.

9. The method of claim 1 further comprising embedding the interaction module through a widget that can be placed across a plurality of social networking platforms to enable users of the plurality of social networking platforms to communicate with the author through the widget.

10. The method of claim 1 in a form of a machine-readable medium embodying a set of instructions that, when executed by a machine, causes the machine to perform the method of claim 1.

11. A system comprising:
an interaction module of a merchant site to automatically apply at least some descriptive content of a literary work offered in the merchant site to an author website based on a preference of an author of the literary work;
a social networking platform associated with the author website which includes users who have shown an affinity for the literary work of the author in the merchant site; and
a communication module of the interaction module to provide a multi-modal communication interface between the users who have shown an affinity for at least one of the literary work and the author.

12. The system of claim 11 further comprising a customization module of the interaction module to modify a look and feel of the author website through a set of tools including a content placement tool, a blogging tool, a multi-media chat tool, a color-theme tool, a bulletin post tool, and an instant messaging tool.

13. A system of claim 11, wherein the multi-modal communication interface is at least one of a video, an audio, a chat, a multimedia, and a blog format between the users who have shown the affinity for at least one of the literary work and the author.

14. A system of claim 11, further comprising a procurement module of the interaction module to enable the users to procure the literary work through at least one of the merchant site and the author website.

15. A system of claim 11, further comprising a finance module of the interaction module to allocate a revenue to the merchant site when the procurement is conducted through the author website.

16. The system of claim 15, further comprising:
a content creation module of the interaction module to enable the author to place an author biography, a set of details of other literary works of the author marketed on the merchant site, and a fan club of patrons of the author in the author website;
a publishing module to enable the author to publish, edit and market the literary work of the author through the merchant website; and
a widget module of the interaction module to place the author website across a plurality of social networking platforms to enable users of the plurality of social networking platforms to communicate with the author through the widget.

17. A method of an interaction module, comprising:
automatically applying a set of attributes associated with a literary work of an author from a merchant site to an author website generated through the interaction module;
customizing a look and feel of the author website based on a preference of the author provided through the interaction module;
accessing a user database of the merchant site to enable a user of the merchant site to communicate with the author through at least one of the author website and the merchant site; and
allocating a payment of the user in procuring the literary work based on an agreement between the merchant site and a partner.

18. The method of claim 18, wherein the author website leverages a description, an ISBN number, and content information from the merchant site.

19. The method of claim 19, wherein the interaction module is leveraged across the plurality of merchant sites such that a single author interaction page is referenced to the plurality of merchant sites.

20. The method of claim 17 further comprising: placing a link to the author website directly adjacent to a location in which the literary work is marketed on the merchant site.
